(19) United States
(12) Patent Application Publication
(10) Pub. No.: US 2021/0010516 A1
(43) Pub. Date: Jan. 14, 2021

(54) BOLT AND NUT CONNECTION STRUCTURE OF OLIVE-SHAPE BIDIRECTIONAL TAPERED THREAD WITH SMALLER LEFT TAPER AND GREATER RIGHT TAPER

(71) Applicant: AMICUS VERITATIS MACHINERY CO., LTD., Taizhou (CN)

(72) Inventor: Yihua YOU, TAIZHOU (CN)

(21) Appl. No.: 17/031,878

(22) Filed: Sep. 24, 2020

Related U.S. Application Data
(63) Continuation of application No. PCT/CN2019/081375, filed on Apr. 4, 2019.

(30) Foreign Application Priority Data
Apr. 7, 2018 (CN) 201810303107.1

(51) Int. Cl. F16B 35/04

(52) U.S. Cl. CPC F16B 35/041

(57) ABSTRACT

The present invention belongs to the technical field of device access, and relates to a bolt and nut connection structure of an olive-shape bidirectional tapered thread with smaller left taper and greater right taper, which solves the problems of poor self-positioning and self-locking performance of existing threads, wherein an internal thread (6) is a bidirectional tapered hole (41) (non-entity space) on an inner surface of a cylindrical body (2); an external thread (9) is a bidirectional truncated cone body (71) (material entity) on an outer surface of a columnar body (3), and a complete unit thread is a bidirectional tapered body in an olive-like shape (93) with a left taper (95) smaller than a right taper (96) and with a large middle and two small ends.

### CROSS-REFERENCE TO RELATED APPLICATIONS

This application is a continuation of International Patent Application No. PCT/CN2019/081375, filed on Apr. 4, 2019, entitled “Bolt and Nut Connection Structure of Olive-Shape Bidirectional Tapered Thread with Smaller Left Taper and Greater Right Taper,” which claims priority to China Patent Application No. 201810303107.1, filed on Apr. 7, 2018. The content of these identified applications are hereby incorporated by references.

### TECHNICAL FIELD

The present invention belongs to the technical field of device access, and particularly relates to a bolt and nut connection structure of an olive-shape bidirectional tapered thread with smaller left taper and greater right taper, i.e., a bolt and nut connection structure of an olive-like (left taper is smaller than right taper) asymmetric bidirectional tapered thread (hereinafter referred to as “the bolt and nut of bidirectional tapered thread”).

### BACKGROUND OF THE PRESENT INVENTION

The invention of thread has a profound impact on the progress of human society. Thread is one of the most basic industrial technologies. It is not a specific product, but a key generic technology in the industry, has the technical performance that must be embodied by specific products as application carriers, and is widely applied in various industries. The existing thread technology has high standardization level, mature technical theory and long-term practical application. It is a fastening thread when used for fastening, is a sealing thread when used for sealing, and is a transmission thread when used for transmission. According to the thread terminology of national standards, the “thread” refers to tooth bodies having the same thread profile and continuously protruding along a helical line on a cylindrical or conical surface; and the “tooth body” refers to a material entity between adjacent flanks. This is also the definition of thread under global consensus.

The modern thread began in 1841 with British Whitworth thread. According to the theory of modern thread technology, the basic condition for self-locking of the thread is that an equivalent friction angle shall not be smaller than a helical rise angle. This is an understanding for the thread technology in modern thread based on a technical principle—“principle of inclined plane”, which has become an important theoretical basis of the modern thread technology. Steven was the first to explain the principle of inclined plane theoretically. He has researched and discovered the parallelogram law for balancing conditions and force composition of objects on the inclined plane. In 1586, he put forward the famous inclined plane law that the gravity of an object placed on the inclined plane in the direction of inclined plane is proportional to the sine of inclination angle. The inclined plane refers to a smooth plane inclined to the horizontal plane; the helix is a deformation of the “inclined plane”; the thread is like an inclined plane wrapped around the cylinder, and the flatter the inclined plane is, the greater the mechanical advantage is (see FIG. 7, i.e., FIG. 7) (Jingshan Yang and Xiuya Wang, Discussion on the Principle of Screws, Disquisitiones Arithmeticae of Gauss).

The “principle of inclined plane” of the modern thread is an inclined plane slider model (see FIG. 8) which is established based on the law of inclined plane. It is believed that the thread pair meets the requirements of self-locking when a thread rise angle is less than or equal to the equivalent friction angle under the condition of little change of static load and temperature. The thread rise angle (see FIG. 9), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF PRESENT INVENTION

Any technical theory has theoretical hypothesis background; and the thread is no exception. With the progress in science and technology, the damage to connection is not simple linear load, static or room temperature environment; and linear load, nonlinear load and even the superposition of the two cause more complex load damaging conditions and complex application conditions. Based on such recognition, the purpose of the present invention is to provide a bolt and nut connection structure of a bidirectional tapered thread with reasonable design, simple structure, and excellent connection performance and locking performance with respect to the above problems.

To achieve the above purpose, the following technical solution is adopted in the present invention: the bolt and nut connection structure of the olive-shape (left taper is smaller than right taper) asymmetric bidirectional tapered thread is used in such a manner that internal threads of asymmetric bidirectional tapered threads and external threads of asymmetric bidirectional tapered threads form a thread connection pair, and is a thread pair technology combining technical characteristics of a cone pair and a helical movement. The bidirectional tapered thread is a thread technology combining the technical characteristics of a bidirectional tapered body and a helical structure. The bidirectional tapered body is composed of two single tapered bodies. i.e., the bidirectional tapered body is composed of two single tapered bodies with reverse left and right tapers and taper of the left taper body is smaller than that of the right taper body. The bidirectional tapered body is helically distributed on the outer surface of a columnar body to form external threads and/or the bidirectional tapered body is helically distributed on the inner surface of a cylindrical body to form internal threads. Regardless of the internal threads or the external threads, a complete unit thread is an olive-shape special bidirectional tapered geometry that is large in middle and small in two ends and has left taper smaller than right taper.

For the bolt and nut of the bidirectional tapered thread, the definition of the olive-like asymmetric bidirectional tapered thread can be expressed as “a helical olive-like special bidirectional tapered geometry that is large in middle and small in two ends, which has asymmetric bidirectional tapered holes (or asymmetric bidirectional truncated cone bodies) with specified left tapers and right tapers reverse in direction and left taper smaller than right taper and is continuously and/or discontinuously distributed along the helical line on cylindrical or conical surfaces”. The head and the tail of the asymmetric bidirectional tapered thread may be incomplete bidirectional tapered geometries due to manufacturing and other reasons. Different from the modern thread technology, the thread technology has changed from the engagement relationship between the internal threads and the external threads of the modern threads to the present cohesion relationship between the internal threads and the external threads of the bidirectional tapered threads.

The bolt and nut of the bidirectional tapered thread comprises a bidirectional truncated cone body helically distributed on an outer surface of a columnar body, and a helical bidirectional tapered hole helically distributed in an inner surface of a cylindrical body, i.e., comprising an external thread and an internal thread in thread fit. The internal thread is a helically distributed bidirectional tapered hole and exists in the form of “non-entity space”. The external thread is distributed as a helical bidirectional truncated cone body and exists in the form of “material entity”. The non-entity space refers to a space environment capable of accommodating the above material entity. The internal thread is a containing part; and the external thread is a contained part. The internal thread and the external thread are sleeved together by screwing bidirectional tapered geometries in pitches, and the threads are cohered until one side bears the load bidirectionally or the left side and the right side bear the load bidirectionally at the same time or until the sizing interference fit is achieved. Whether the two sides bear bidirectional load at the same time is related to the actual working conditions in the application field, i.e., the bidirectional tapered holes are fitted with the bidirectional truncated cone body pitch by pitch, i.e., the internal thread is fitted with the corresponding external thread in pitches.

The thread connection pair is a thread pair formed by fitting a helical outer conical surface with a helical inner conical surface to form a cone pair. The outer conical surface of the external cone body of the bidirectional tapered thread and the inner conical surface of the internal cone body are bidirectional conical surfaces. When the thread connection pair is formed between the bidirectional tapered threads, a joint surface between the inner conical surface and the outer conical surface is used as a bearing surface, i.e., the conical surface is used as the bearing surface to realize the technical performance of connection. The self-locking, self-positioning, reusability, fatigue resistance and other capabilities of the thread pair mainly depend on the conical surface of the cone pair of the connection structure of the bolt of the bidirectional tapered thread and the nut the bolt of the bidirectional tapered thread and the nut and taper size of the conical surface, i.e., the conical surface of the internal and external threads and the taper size of the conical surface. The thread pair is a non-toothed thread.

Different from that the principle of inclined plane of the existing thread shows a unidirectional force distributed on the inclined plane as well as the internal and external threads represent an engagement relationship of inner tooth bodies and outer tooth bodies, the single tapered body distributed on either one of the left side or the right side of the external thread body, i.e., the bidirectional tapered body, of the bolt and nut of the bidirectional tapered thread is composed of two plain lines of the cone body in two directions through a cross section of a cone axis, i.e., in a bidirectional state, wherein the plain lines are intersection lines of the conical surfaces and a plane through which the cone axis passes. The cone principle of the bolt and nut connection structure of the bidirectional tapered thread shows an axial force and a counter-axial force, both of which are synthesized by bidirectional forces, wherein the axial force and the corresponding counter-axial force are opposite to each other. The internal thread and the external thread are in a cohesion relationship, i.e., the thread pair is formed by cohering the external thread with the internal thread, i.e., the tapered hole (internal cone) is cohered with the corresponding tapered cone body (external cone body) in pitches until the self-positioning is realized by cohesion sizing fit or until the self-locking is realized by sizing interference contact. Namely, the self-locking or self-positioning of the internal cone body and the external cone body is realized by radially cohering the tapered hole and the truncated cone body to realize the self-locking or self-positioning of the thread pair, rather than the thread connection performance is realized by mutual abutment between the tooth bodies for the thread connection pair composed of the internal thread and the external thread of the traditional thread.

A self-locking force will arise when the cohesion process between the internal thread and the external thread reaches certain conditions, and is generated by the pressure produced between the axial force of the internal cone and the counter-axial force of the external cone. Namely, when the internal cone and the external cone form the cone pair, the inner conical surface of the internal cone body is cohered with the outer conical surface of the external cone body; and the inner conical surface is in close contact with the outer conical surface. The axial force of the internal cone and the counter-axial force of the external cone are concepts of forces unique to the bidirectional tapered thread technology of the present invention, i.e., the cone pair technology.

The internal cone body exists in a form similar to a shaft sleeve, and generates the axial force pointing to or pressing toward the cone axis under the action of external load. The axial force is bidirectionally synthesized by a pair of centripetal forces which are distributed in mirror image with the cone axis as a center and are respectively perpendicular to the two plain lines of the cone body; i.e., the axial force passes through the cross section of the cone axis and is composed of two centripetal forces which are bidirectionally distributed on two sides of the cone axis in mirror image with the cone axis as the center, are respectively perpendicular to the two plain lines of the cone body, and point to or press toward a common point of the cone axis; and the axial force passes through the cross section of a thread axis and is composed of two centripetal forces which are bidirectionally distributed on two sides of the thread axis in mirror image and/or approximate mirror image with the thread axis as the center, are respectively perpendicular to two plain lines of the cone body, and point to or press toward the common point and/or approximate common point of the thread axis when the thread is synthesized by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates the counter-axial force opposite to each axial force of the internal cone body. The counter-axial force is bidirectionally synthesized by a pair of counter-centripetal forces which are distributed in mirror image with the cone axis as a center and are respectively perpendicular to the two plain lines of the cone body, i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of a thread axis and is composed of two counter-centripetal forces which are bidirectionally distributed on two sides of the thread axis in mirror image and/or approximate mirror image with the thread axis as the center, are respectively perpendicular to two plain lines of the cone body, and point to or press toward the common point and/or approximate common point of the thread axis when the thread is synthesized by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are cohered until interference is achieved, so the axial force and the counter-axial force generate the pressure on the contact surface between the inner conical surface and the outer conical surface and are uniformly distributed on the contact surface between the inner conical surface and the outer conical surface axially and circumferentially. When the cohesion movement of the internal cone and the external cone continues until the cone pair reaches the pressure generated by interference fit to combine the internal cone with the external cone, i.e., the pressure enables the internal cone body to be cohered with the external cone body to form a similar integral structure and will not cause the internal cone body and the external cone body to separate from each other under the action of gravity due to the arbitrary change in the direction of the body position of the similar integral structure after the external force caused by the pressure disappears, the cone pair generates self-locking, i.e., the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other, but not any axial force angle and/or counter-axial force angle can make the cone pair generate self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation until the cone pair completely has no self-locking ability; and the axial bearing capacity changes in a direction of enhancement until the axial bearing capacity is the strongest.

When the axial force angle and/or the counter-axial force angle is less than 180° and greater than 127, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal cone body and the external cone body of the cone pair changes in the direction of attenuation until the cone pair approximately completely has no self-positioning ability.

According to the bidirectional tapered thread connection pair, compared with the containing and contained relationship of irreversible one-sided bidirectional containment that the unidirectional tapered thread of single tapered body invented by the applicant before can only bear the load by one side of the conical surface, the reversible left and right-sided bidirectional containment of the bidirectional tapered threads of double tapered bodies enables the left side and/or the right side of the conical surface to bear the load, and/or the left conical surface and the right conical surface to respectively bear the load, and/or the left conical surface and the right conical surface to simultaneously bear the load bidirectionally, and further limits the disordered degree of freedom between the tapered hole and the truncated cone body; and the helical movement enables the bolt and nut connection structure of the bidirectional tapered thread to obtain the necessary ordered degree of freedom, thereby effectively synthesizing the technical characteristics of the cone pair and the thread pair to form a brand-new thread technology.

When the bolt and nut of the bidirectional tapered thread is used, the conical surface of the bidirectional truncated cone body of the external thread of the bidirectional tapered thread and the conical surface of the bidirectional tapered hole of the internal thread of the bidirectional tapered thread are fitted with each other.

According to the bolt and nut of the bidirectional tapered thread, the self-locking and/or self-positioning of the thread connection pair is not realized at any taper or any taper angle of the bidirectional tapered body of the cone pair, i.e., the truncated cone body and/or the tapered hole. The bolt and nut connection structure of the bidirectional tapered thread has the self-locking and self-positioning performances only if the internal and external cone bodies of the bidirectional tapered body reach a certain taper, or a certain taper. The taper comprises the left taper and the right taper of the internal and external threads. The taper angle includes left taper angles and right taper angles of the internal and external thread bodies. The internal thread and the external thread of the asymmetric bidirectional tapered thread forming the connection structure of the bolt of the olive-like asymmetric bidirectional tapered thread and the nut have the left taper smaller than the right taper. For the taper angle, the left taper corresponds to a first taper angle α1. Preferably, the first taper angle α1 is greater than 0° and smaller than 53; and preferably, the first taper angle α1 is 2°-40°. The right taper corresponds to the right taper angle, that is, a second taper angle α2. It is preferable that the second taper angle α2 is greater than 0° and smaller than 53°; and preferably, the second taper angle α2 is 2°-40°. In individual special fields, preferably, the second taper angle α2 is greater than or equal to 53 and smaller than 180°; and preferably, the second taper angle α1 is 53°-90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

In the bolt and nut of the bidirectional tapered thread, the external thread is arranged on the outer surface of the columnar body to form a bolt, wherein the columnar body is provided with a screw body; a truncated cone body is helically distributed on the outer surface of the screw body. The truncated cone body includes an asymmetric bidirectional truncated cone body. The columnar body may be solid or hollow, including cylindrical and/or non-cylindrical workpieces and objects that need to be machined with threads on the outer surfaces, including cylindrical surfaces, non-cylindrical surfaces such as conical surfaces, and outer surfaces.

According to the bolt and nut of the bidirectional tapered thread, the internal thread is arranged on the inner surface of the cylindrical body to form a nut, wherein the cylindrical body is provided with a nut body; a tapered hole is helically distributed in the inner surface of the nut body. The tapered hole includes an asymmetric bidirectional tapered hole. The cylindrical body includes cylindrical and/or non-cylindrical workpieces and objects which need to be machined with the internal threads on the inner surfaces, wherein the inner surfaces include cylindrical surfaces, non-cylindrical surfaces such as conical surfaces, and inner surfaces of other geometric shapes.

For the bolt and nut of the bidirectional tapered thread, the asymmetric bidirectional truncated cone body, i.e., the internal thread is formed as follows: lower bottom surfaces of two tapered holes with the same lower bottom surfaces and upper top surfaces and different cone heights are symmetrically and oppositely jointed with each other in a helical shape to form the thread. The upper top surfaces are located at both ends of the bidirectional truncated cone body to form the olive-like asymmetric bidirectional tapered thread, the process includes that the lower bottom surfaces are respectively jointed with the upper top surfaces of the adjacent bidirectional truncated cone bodies and/or will be respectively jointed with the upper top surfaces of the adjacent bidirectional truncated cone bodies in the helical shape to form the thread. The internal thread includes a first helical conical surface of the tapered hole, a second helical conical surface of the tapered hole and an internal helical line. In the cross section through which the thread axis passes, a complete single-pitch asymmetric bidirectional tapered internal thread, is a special bidirectional tapered geometry in the olive-like shape and with a large middle and two small ends and left taper smaller than right taper. The angle formed between the two plain lines of the left conical surface of the bidirectional tapered hole including the conical surface of the bidirectional tapered hole, is the first taper angle α1. The left taper is formed on the first helical conical surface of the tapered hole and is subjected to a left-direction distribution. The angle formed between the two plain lines of the right conical surface, i.e., the second helical conical surface of the tapered hole, is the second taper angle α2. The right taper is formed on the second helical conical surface of the tapered hole and is subjected to a right-direction distribution. The taper directions corresponding to the first taper angle α1 and the second taper angle α2 are opposite. The plain line is an intersection line of the conical surface and the plane through which the cone axis passes. The shape formed by the first helical conical surface and the second helical conical surface of the tapered hole of the bidirectional tapered hole is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body, wherein the right-angled side is coincident with the central axis of the columnar body, and the right-angled trapezoid union is formed by symmetrically and oppositely jointing lower bottom sides of two right-angled trapezoids with the same lower bottom sides and upper bottom sides and different right-angled sides. The right-angled trapezoid union refers to a special geometry, which is formed by symmetrically and oppositely jointing the lower bottom sides of two right-angled trapezoids with the same lower bottom sides and upper bottom sides and different right-angled sides and has the upper bottom sides respectively located at both ends of the right-angled trapezoid union.

When the bolt and nut connection structure of the bidirectional tapered thread works, relationships with the workpieces include rigid connection and non-rigid connection. The rigid connection is that a nut bearing surface and a workpiece bearing surface are mutually bearing surfaces, and includes structural forms such as single nut and double nuts. The non-rigid connection is that opposite lateral end faces of two nuts are mutually bearing surfaces and/or the opposite lateral end faces of two nuts are indirectly mutually bearing surfaces due to a gasket arranged therebetween, and is mainly applied to non-rigid materials or driving parts and other non-rigid connection workpieces or application fields in which requirements are met by virtue of double-nut installation. The workpieces refer to connected objects including the workpieces. The gaskets refer to spacers including gaskets.

According to the bolt and nut of the bidirectional tapered thread, when the relationship between the connection structure of the bolt and double nuts and the fastened workpiece is the rigid connection, thread operation bearing surfaces are different. When the cylindrical body is located on the left side of the fastened workpiece, that is, when the left end face of the fastened workpiece and the right end face of a left nut body of the cylindrical body, i.e., the left nut body, is a locking bearing surface of the left nut body and the fastened workpiece, a right helical conical surface of the left nut body and the cylindrical body, i.e., the screw body, i.e., the bidirectional tapered thread of the bolt, i.e., the second helical conical surface of the tapered hole and the second helical conical surface of the truncated cone body are tapered thread bearing surfaces, and the second helical conical surface of the tapered hole and the second helical conical surface of the truncated cone body are mutually bearing surfaces. When the cylindrical body is located on the right side of the fastened workpiece, that is, when the right end face of the fastened workpiece and the left end face of the cylindrical body, i.e., the right nut body, is a locking bearing surface of the right nut body and the fastened workpiece, a left helical conical surface of the right nut body and the cylindrical body, i.e., the screw body, i.e., the bidirectional tapered thread of the bolt, i.e., a first helical conical surface of the tapered hole and the first helical conical surface of the truncated cone body are tapered thread bearing surfaces, and the first helical conical surface of the tapered hole and the first helical conical surface of the truncated cone body are mutually bearing surfaces.

According to the bolt and nut of the bidirectional tapered thread, when the relationship between the connection structure of the bolt and a single nut and the fastened workpiece is the rigid connection, when a bolt hexagon head part is located on the left side, the cylindrical body, i.e., the nut body, that is, a single nut, is located on the right side of the fastened workpiece, during operation of the connection structure of the bolt and the single nut, the right end face of the workpiece and the left end face of the nut body are locking bearing surfaces of the nut body and the fastened workpiece, a left helical conical surface of the nut body and the columnar body, i.e., the screw body, i.e., the bolt of the bidirectional tapered thread, i.e., a first helical conical surface of the tapered hole and the first helical conical surface of the truncated cone body are tapered thread bearing surfaces, and the first helical conical surface of the tapered hole and the first helical conical surface of the truncated cone body are mutually bearing surfaces. When the bolt hexagon head part is located on the right side, the cylindrical body, i.e., the nut body, that is, the single nut, is located on the left side of the fastened workpiece, during operation of the connection structure of the bolt and the single nut, the left end face of the workpiece and the right end face of the nut body are locking bearing surfaces of the nut body and the fastened workpiece, a right helical conical surface of the nut body and the columnar body, i.e., the screw body, i.e., the bolt of the bidirectional tapered thread, i.e., a second helical conical surface of the tapered hole and the second helical conical surface of the truncated cone body are tapered thread bearing surfaces, and the second conical surface of the tapered hole and the second helical conical surface of the truncated cone body are mutually bearing surfaces.

According to the bolt and nut of the bidirectional tapered thread, when the relationship between the connection structure of the bolt and double nuts and the fastened workpiece is the non-rigid connection, thread operation bearing surfaces, i.e., the tapered thread bearing surfaces are different. The cylindrical body includes a left nut body and a right nut body. A right end face of the left nut body and a left end face of the right nut body are in opposite and direct contact and are mutually locking bearing surfaces. When the right end face of the left nut body is a locking bearing surface, the right helical conical surface of the left nut body and the columnar body, i.e., the screw body, i.e., the bolt of the bidirectional tapered thread, i.e., a second helical conical surface of the tapered hole and the second helical conical surface of the truncated cone body of the bidirectional tapered external thread are tapered thread bearing surfaces, and the second helical conical surface of the tapered hole and the second helical conical surface of the truncated cone body are mutually bearing surfaces. When the left end face of the right nut body is a locking bearing surface, the left helical conical surface of the right nut body and the columnar body, i.e., the screw body, i.e., the bolt of the bidirectional tapered thread, i.e., a first helical conical surface of the tapered hole and the first helical conical surface of the truncated cone body are tapered thread bearing surfaces, and the first helical conical surface of the tapered hole and the first helical conical surface of the truncated cone body are mutually bearing surfaces.

According to the bolt and nut of the bidirectional tapered thread, when the relationship between the connection structure of the bolt and double nuts and the fastened workpiece is the non-rigid connection, the tapered thread bearing surfaces are different. The cylindrical body includes a left nut body and a right nut body, and a spacer like a gasket is arranged between the two cylindrical bodyes, i.e., the left nut body and the right nut body. The right end face of the left nut body and the left end face of the right nut body are in opposite and indirect contact by virtue of the gasket so as to be indirectly mutual locking bearing surfaces. When the cylindrical body is located on the left side of the gasket, that is, when the left side face of the gasket and the right end face of the left nut body are the locking bearing surface of the left nut body, the right helical conical surface of the left nut body and the columnar body, i.e., the screw body, i.e., the bolt of the bidirectional tapered thread, i.e., a second helical conical surface of the and the second helical conical surface of the truncated cone body are tapered thread bearing surfaces, and the second helical conical surface of the tapered hole and the second helical conical surface of the truncated cone body are mutually bearing surfaces. When the cylindrical body is located on the right side of the gasket, that is, when the right side face of the gasket and the left end face of the right nut body are the locking bearing surface of the right nut body, the left helical conical surface of the right nut body and the columnar body, i.e., the screw body, i.e., the bolt of the bidirectional tapered thread, i.e., a first helical conical surface of the tapered hole and the first helical conical surface of the truncated cone body of the bidirectional tapered external thread are tapered thread bearing surfaces, and the first helical conical surface of the tapered hole and the first helical conical surface of the truncated cone body are mutually bearing surfaces.

According to the bolt and nut of the bidirectional tapered thread, when the relationship between the connection structure of the bolt and double nuts and the fastened workpiece is the non-rigid connection, when the above cylindrical body located on the inner side, i.e., the nut body adjacent to the fastened workpiece, has been effectively jointed with the columnar body, i.e., the screw body, i.e., the bolt, that is, when the internal thread and the external thread forming the tapered thread connection pair are effectively cohered together, the cylindrical body located on the outer side, i.e., a nut body that is not adjacent to the fastened workpiece, may maintain the original shape and/or be removed according to needs of application conditions, while only one nut is remained (e.g., application fields in which requirements on equipment lightweight exist or connection technology reliability is ensured without double nuts). The removed nut body does not serve as a connecting nut, but an installation process nut. Internal threads of the installation process nuts are manufactured from the bidirectional tapered threads, and may also be nut bodies manufactured from threads of unidirectional tapered threads, other threads that may be in threaded screwing with the tapered threads, including triangular threads, trapezoidal threads, sawtooth threads and the like, and non-tapered threads, which is the precondition of ensuring the connection technology reliability. The tapered thread connection pair is a closed loop fastening technology system. Namely, after the internal thread and the external thread of the tapered thread connection pair are effectively cohered together, the thread connection pair may form an independent technology system itself without depending on technical compensation of a third party, so as to ensure the technical effectiveness of the connection technology system. Even if there is no support of other objects, and even if a gap exists between the tapered thread connection pair and the fastened workpiece, effectiveness of the tapered thread connection pair is not influenced, which contributes to greatly lightening equipment weight, removing invalid loads, and improving technical requirements of equipment, such as payload capability, brake performance and energy conservation and emission reduction. The above descriptions are thread technology advantages that are not owned by other thread technologies when the relationship between the bolt and nut connection structure of the bidirectional tapered thread and the fastened workpiece is the rigid connection or non-rigid connection.

According to the bolt and nut of the bidirectional tapered thread, during transmission connection, by virtue of screwed connection between the bidirectional tapered hole and the bidirectional truncated cone body and bidirectional bearing, when the external thread and the internal thread form the thread pair, a clearance must be reserved between the bidirectional truncated cone body and the bidirectional tapered hole. If oil and other media exist between the internal thread and the external thread for lubrication, a bearing oil film will be easily formed; and the clearance is beneficial to the formation of the bearing oil film. The bolt and nut of the bidirectional tapered thread applied to transmission connection is equivalent to a set of sliding bearing pairs composed of one and/or several pairs of sliding bearings, i.e., each pitch of the bidirectional tapered internal thread bidirectionally contains a corresponding pitch of bidirectional tapered external thread to form a pair of sliding bearings. The number of sliding bearings is adjusted according to application conditions. Namely, the number of the effective bidirectional jointed, i.e., the effective bidirectional contact cohered, containing and contained thread pitches of the bidirectional tapered internal thread and the bidirectional tapered external thread is designed according to the application conditions. The multidirectional positioning of the internal cone body and the external cone body is formed through the containment of the bidirectional truncated cone body by the bidirectional tapered hole and the positioning in multiple directions such as radial, axial, angular and circumferential directions, preferably through the containment of the bidirectional truncated cone body by the bidirectional tapered hole and the main positioning in the radial and circumferential directions supplemented by the auxiliary positioning in the axial and angular directions, until the conical surface of the bidirectional tapered hole is cohered with the conical surface of the bidirectional truncated cone body to implement self-positioning or until the sizing interference contact is achieved to generate self-locking, which constitutes a special synthesis technology of the cone pair and the thread pair to ensure the precision, efficiency and reliability of the tapered thread technology, particularly the transmission connection of the bolt and nut connection structure of the bidirectional tapered thread.

When the bolt and nut of the bidirectional tapered thread is used for fastening connection and sealing connection, the technical performances are realized through the screwing connection of the bidirectional tapered hole and the bidirectional truncated cone body, i.e., are realized through the sizing of the first helical conical surface of the truncated cone body and the first helical conical surface of the tapered hole until interference and/or the sizing of the second helical conical surface of the truncated cone body and the second helical conical surface of the tapered hole until interference. The load is borne in one direction and/or respectively borne in two directions at the same time according to the application conditions, i.e., the bidirectional truncated cone body and the bidirectional tapered hole are guided by the helical line to align the inner diameter and the outer diameter of the internal cone and the external cone until the first helical conical surface of the tapered hole is adhered with the first helical conical surface of the truncated cone body until the sizing fit of bearing in one direction or simultaneously bearing in two directions or sizing interference contact is achieved, and/or the second helical conical surface of the tapered hole is cohered with the second helical conical surface of the truncated cone body until the sizing fit of bearing in one direction or simultaneously bearing in two directions or sizing interference contact is achieved. Self-locking of containment of the bidirectional internal cone of the tapered internal thread and the bidirectional external cone of the tapered external thread and the multidirectional positioning in multiple directions such as radial, axial, angular and circumferential directions are formed, preferably through the containment of the bidirectional truncated cone body by the bidirectional tapered hole and the main positioning in the radial and circumferential directions supplemented by the auxiliary positioning in the axial and angular directions, until the conical surface of the bidirectional tapered hole is cohered with the conical surface of the bidirectional truncated cone body to implement self-positioning or until the sizing interference contact is achieved to generate self-locking, which constitutes a special synthesis technology of the cone pair and the thread pair and ensures efficiency and reliability of the tapered thread technology, particularly the bolt and nut of the bidirectional tapered thread, so as to realize the technical performances of a mechanical mechanism, such as connection, locking, anti-loosening, bearing, fatigue and sealing.

Therefore, the technical performances such as the transmission precision and efficiency, the load bearing capacity, the locking force of self-locking, the anti-loosening ability and the sealing performance of the mechanical mechanism using the bolt and nut of the bidirectional tapered thread are related to the sizes of the first helical conical surface of the truncated cone body and the formed left taper, i.e., the first taper angle α1, the second helical conical surface of the truncated cone body and the formed right taper, i.e., the second taper angle α2, and the sizes of the first helical conical surface of the tapered hole and the formed left taper, i.e., the first taper angle α1, and the second helical conical surface of the tapered hole and the formed right taper. Material friction coefficient, processing quality and application conditions of the columnar body and the cylindrical body also have a certain impact on the technical performances.

In the bolt and nut of the bidirectional tapered thread, when the right-angled trapezoid union rotates a circle at a constant speed, the axial movement distance of the right-angled trapezoid union is at least double the length of the sum of the right-angled sides of two right-angled trapezoids with the same lower bottom sides and upper bottom sides and different right-angled sides. The structure ensures that the first helical conical surface and the second helical conical surface of the truncated cone body and the first helical conical surface and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

In the bolt and nut of the bidirectional tapered thread, when the right-angled trapezoid union rotates a circle at a constant speed, the axial movement distance of the right-angled trapezoid union is equal to the length of the sum of the right-angled sides of two right-angled trapezoids with the same lower bottom sides and upper bottom sides and different right-angled sides. The structure ensures that the first helical conical surface of the truncated cone body and the second helical conical surface of the truncated cone body and the first helical conical surface and the second helical conical surface of the tapered hole have sufficient length, thereby ensuring that the conical surface of the bidirectional truncated cone body and the conical surface of the bidirectional tapered hole have sufficient effective contact area and strength and the efficiency required by helical movement during fitting.

In the bolt and nut of the bidirectional tapered thread, the first helical conical surface of the truncated cone body and the second helical conical surface of the truncated cone body are both continuous helical surfaces or discontinuous helical surfaces; and the first helical conical surface of the tapered hole and the second helical conical surface of the tapered hole are both continuous helical surfaces or discontinuous helical surfaces.

In the bolt and nut of the bidirectional tapered thread, when the connecting hole of the cylindrical body is screwed into the screw-in end of the columnar body, the screw-in direction is required, i.e., the connecting hole of the cylindrical body cannot be reversely screwed in.

In the bolt and nut of the bidirectional tapered thread, a head with the size greater than an outer diameter of the columnar body is arranged at one end of the columnar body, and/or a head with the size smaller than a minor diameter of the bidirectional tapered external thread of the columnar body is arranged at one end and/or two ends of the columnar body, wherein the connecting hole is a threaded hole formed in a nut. Namely, the columnar body connected with the head is a bolt; and the columnar body having no head and/or having heads at both ends smaller than the minor diameter of the bidirectional tapered external thread and/or having no thread at the middle and having the bidirectional tapered external threads at both ends is a stud, wherein the connecting hole is formed in the nut.

Compared with the prior art, the bolt and nut connection structure of the bidirectional tapered thread has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of the cone pair formed by coaxially aligning the inner diameter and the outer diameter of the internal cone and the external cone to achieve interference fit, can prevent loosening phenomenon during connection, and has self-locking and self-positioning functions.

### DESCRIPTION OF THE DRAWINGS

FIG. 1 is a structural schematic diagram of a connection structure of a bolt and double nuts of an olive-like (a left taper is smaller than a right taper) asymmetric bidirectional tapered thread according to an embodiment 1 of the present invention;

FIG. 2 is a structural schematic diagram of a bolt of an external thread of the olive-like (the left taper is smaller than the right taper) bidirectional tapered thread and a complete unit thread of the external thread according to the embodiment 1 of the present invention;

FIG. 3 is a structural schematic diagram of a nut body of an internal thread of an olive-like (the left taper is smaller than the right taper) bidirectional tapered thread and a complete unit thread of the internal thread according to the embodiment 1 of the present invention;

FIG. 4 is a structural schematic diagram of a connection structure of bolts and a single nut of an olive-like (the left taper is smaller than the right taper) asymmetric bidirectional tapered thread according to an embodiment 2 of the present invention;

FIG. 5 is a structural schematic diagram of a connection structure of bolts and double nuts of an olive-like (the left taper is smaller than the right taper) asymmetric bidirectional tapered thread according to the embodiment 3 of the present invention;

FIG. 6 is a structural schematic diagram of a connection structure of bolts and double nuts of an olive-like (the left taper is smaller than the right taper) asymmetric bidirectional tapered thread (with a gasket between the double nuts) according to the embodiment 4 of the present invention;

FIG. 7 is a graphic presentation of “the thread of the existing thread technology is an inclined plane on a cylindrical or conical surface” involved in the background of the present invention;

FIG. 8 is a graphic presentation of “an inclined plane slider model of the principle of the existing thread technology—the principle of inclined plane” involved in the background of the present invention; and

FIG. 9 is a graphic presentation of “a thread rise angle of the existing thread technology” involved in the background of the present invention.

In the figures, tapered thread 1, cylindrical body 2, nut body 21, nut body 22, columnar body 3, screw body 31, tapered hole 4, bidirectional tapered hole 41, conical surface 42 of bidirectional tapered hole, first helical conical surface 421 of tapered hole, first taper angle α1, second helical conical surface 422 of tapered hole, second taper angle α2, internal helical line 5, internal thread 6, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, olive-like shape 93, left taper 95, right taper 96, left-direction distribution 97, right-direction distribution 98, thread connection pair and/or thread pair 10, clearance 101, locking bearing surface 111, locking bearing surface 112, tapered thread bearing surface 122, tapered thread bearing surface 121, workpiece 130, nut body locking direction 131, gasket 132, cone axis 01, thread axis 02, slider A on the inclined surface, inclined surface B, gravity G, gravity component G1 along the inclined plane, friction force F, thread rise angle φ, equivalent friction angle P, major diameter d of the traditional external thread, minor diameter d1 of the traditional external thread and pitch diameter d2 of the traditional external thread.

### DETAILED DESCRIPTION OF PREFERRED EMBODIMENTS

The present invention will be further described in detail below with reference to the accompany drawings and specific embodiments.

### Embodiment 1

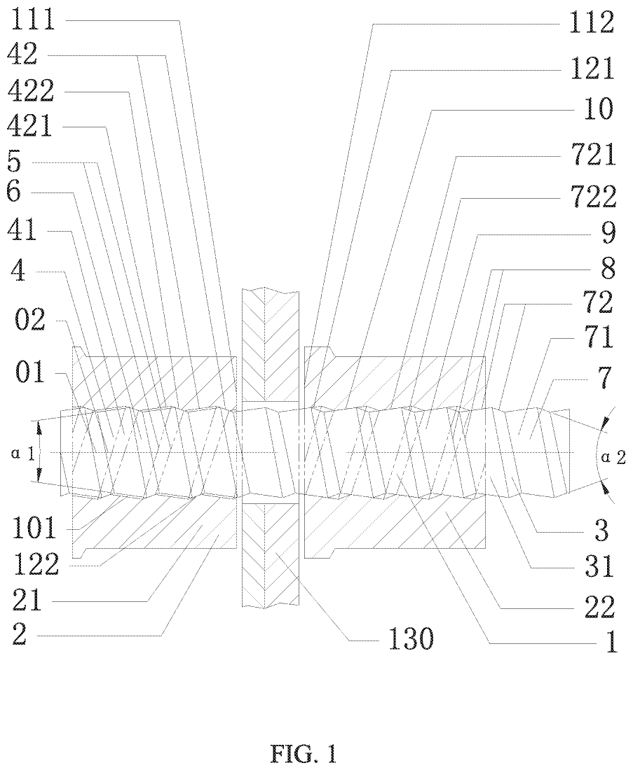

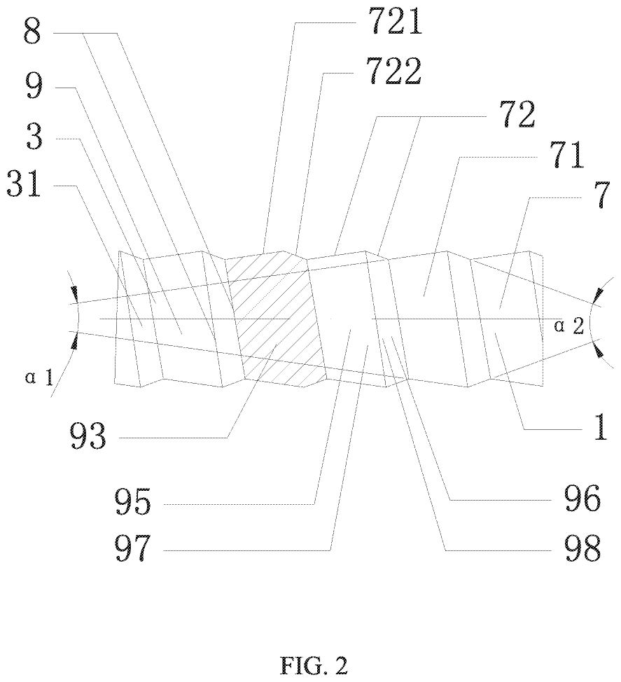

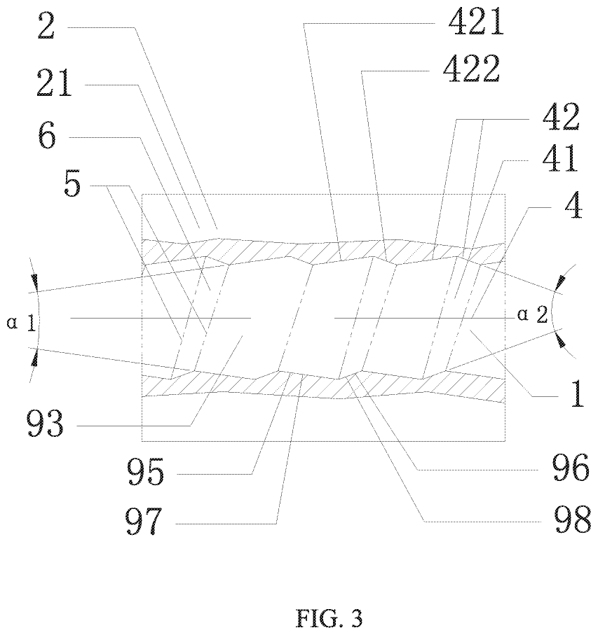

As shown in FIGS. 1, 2 and 3, a connection structure of a bolt and double nuts is adopted in the present embodiment. The connection structure includes a bidirectional truncated cone body 71 helically distributed on an outer surface of a columnar body 3 and a bidirectional tapered hole 41 helically distributed in an inner surface of a cylindrical body 2, namely, comprises an external thread 9 and an internal thread 6 which are in threaded fitting with each other. The internal thread 6 is distributed as a helical bidirectional helical tapered hole 41 and exists in the form of “non-entity space”; and the external thread 9 is a distributed as a helical bidirectional truncated cone body 71 and exists in the form of “material entity”. The internal thread 6 and the external thread 9 are subjected to a relationship of containing part and contained part. The internal thread 6 and the external thread 9 are sleeved together by screwing pitch by pitch in bidirectional tapered geometry and cohered until interference fit is achieved, i.e., the bidirectional tapered hole 41 contains the bidirectional truncated cone body 71 pitch by pitch. The bidirectional containment limits the disordered degree of freedom between the tapered hole 4 and the truncated cone body 7; the helical movement enables the tapered thread connection pair 10 of the bidirectional tapered thread and the nut to obtain the necessary ordered degree of freedom, thereby effectively synthesizing the technical characteristics of the cone pair and the thread pair.

The tapered thread connection pair 10 of the bolt and nut of the bidirectional tapered thread in the present embodiment has the self-locking and self-positioning performances only if the truncated cone body 7 and/or the tapered hole 4 reaches a certain taper. i.e., the cone bodies forming the cone pair reach a certain taper angle. The taper comprises a left taper 95 and a right taper 96, i.e., the taper angle comprises a left taper angle and a right taper angle. In the present embodiment, the asymmetric bidirectional tapered thread 1 has the left taper 95 smaller than the right taper 96. The left taper 95 corresponds to the left taper angle, i.e., a first taper angle α1. Preferably, the first taper angle α1 is greater than 0 and smaller than 53; and preferably, the first taper angle α1 is 2°-40°. The right taper 96 corresponds to the right taper angle, i.e., a second taper angle α2. Preferably, the second taper angle α2 is greater than 0° and smaller than 53°; and preferably, the second taper angle α2 is 2°-40°. In individual special fields, that is, in connection application fields in which the self-locking performance is not needed and/or the self-positioning requirement is low and/or an axial bearing force requirement is high, preferably, the second taper angle α2 is greater than or equal to 53° and smaller than 180°; and preferably, the second taper angle α2 is 53°-90°.

The external thread 9 is arranged on the outer surface of the columnar body 3, wherein the columnar body 3 is provided with a screw body 31; the truncated cone body 7 is helically distributed on the outer surface of the screw body 31; and the truncated cone body 7 comprises the asymmetric bidirectional truncated cone body 71. The asymmetric bidirectional truncated cone body 71 is a special bidirectional tapered geometry in the olive shape 93. The columnar body 3 may be solid or hollow, including cylinders, cones, tubes and other workpieces and objects on outer surfaces of which external threads need to be processed.

The asymmetric bidirectional truncated cone body 71 in the olive-like shape 93 is formed by symmetrically and oppositely jointing lower bottom surfaces of two truncated cone bodies with the same lower bottom surfaces and upper top surfaces and different cone heights. The upper top surfaces are located at both ends of the bidirectional truncated cone body 71 to form the asymmetric bidirectional tapered thread 1, the process includes that the lower bottom surfaces are respectively jointed with the upper top surfaces of the adjacent bidirectional truncated cone bodies 71 and/or will be respectively jointed with the upper top surfaces of the adjacent bidirectional truncated cone bodies 71. The outer surface of the truncated cone body 71 is provided with a conical surface 72 of the asymmetric bidirectional truncated cone body. The external thread 9 includes a first helical conical surface 721 of the truncated cone body, a second helical conical surface 722 of the truncated cone body and an external helical line 8. In the cross section through which the thread axis 02 passes, a complete single-pitch asymmetric bidirectional tapered external thread 9 is a special bidirectional tapered geometry in the olive-like shape 93 and with a large middle and two small ends and with the taper of the left truncated cone body smaller than the taper of the right truncated cone body. The asymmetric bidirectional truncated cone body 71 includes a conical surface 72 of the bidirectional truncated cone body. The angle formed between two plain lines of the left conical surface of the bidirectional truncated cone body 71, i.e., the first helical conical surface 721 of the truncated cone body, is the first taper angle α1. The left taper 95 is formed on the first helical conical surface 721 of the truncated cone body and is subjected to a left-direction distribution 97. The angle formed between the two plain lines of the right conical surface of the asymmetric bidirectional truncated cone body 71, i.e., the second helical conical surface 722 of the truncated cone body, is the second taper angle α2. The right taper 96 is formed on the second helical conical surface 722 of the truncated cone body and is subjected to a right-direction distribution 98. The taper directions corresponding to the first taper angle α1 and the second taper angle α2 are opposite. The plain line is an intersection line of the conical surface and the plane through which the cone axis passes 01. The shape formed by the first helical conical surface 721 and the second helical conical surface 722 of the truncated cone body of the bidirectional truncated cone body 71 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body 3, wherein the right-angled side is coincident with the central axis of the columnar body 3; and the right-angled trapezoid union is formed by symmetrically and oppositely jointing lower bottom sides of two right-angled trapezoids with the same lower bottom sides and upper bottom sides and different right-angled sides. The right-angled trapezoid union refers to a special geometry, which is formed by symmetrically and oppositely jointing the lower bottom sides of two right-angled trapezoids with the same lower bottom sides and upper bottom sides and different right-angled sides and has the upper bottom sides respectively located at both ends of the right-angled trapezoid union.

The internal thread 6 is arranged on the inner surface of the cylindrical body 2. The cylindrical body 2 comprises a nut body 21 and a nut body 22. Helically distributed tapered holes 4 are formed in inner surfaces of the nut body 21 and the nut body 22. The tapered holes 4 comprise asymmetric bidirectional tapered holes 41. The asymmetric bidirectional tapered hole 41 is a special bidirectional tapered geometry in the olive shape 93. The cylindrical body 2 includes cylindrical and/or non-cylindrical workpieces and objects that need to be machined with the internal threads on the inner surfaces.

The asymmetric bidirectional tapered hole 41 in the olive-like shape 93 is formed by symmetrically and oppositely jointing lower bottom surfaces of two tapered holes with the same lower bottom surfaces and upper top surfaces and different cone heights. The upper top surfaces are located at both ends of the bidirectional tapered hole 41 to form the asymmetric bidirectional tapered thread 1, the process includes that the upper top surfaces are respectively jointed with the upper top surfaces of the adjacent bidirectional tapered holes 41 and/or will be respectively jointed with the upper top surfaces of the adjacent bidirectional tapered holes 41 to form the thread. The internal thread 6 includes a first helical conical surface 421 of the tapered hole, a second helical conical surface 422 of the tapered hole and an internal helical line 5. In the cross section through which the thread axis 02 passes, a complete single-pitch asymmetric bidirectional tapered internal thread 6, is a special bidirectional tapered geometry in the olive-like shape 93 and with a large middle and two small ends and left taper smaller than right taper. The angle formed between the two plain lines of the left conical surface of the bidirectional tapered hole including the conical surface 42 of the bidirectional tapered hole 41, i.e., the first helical conical surface 421 of the tapered hole, is the first taper angle α1. The left taper 95 is formed on the first helical conical surface 421 of the tapered hole and is subjected to a left-direction distribution 97. The angle formed between the two plain lines of the right conical surface, i.e., the second helical conical surface 422 of the tapered hole, is the second taper angle α2. The right taper 96 is formed on the second helical conical surface 422 of the tapered hole and is subjected to a right-direction distribution 98. The taper directions corresponding to the first taper angle α1 and the second taper angle α2 are opposite. The plain line is an intersection line of the conical surface and the plane through which the cone axis passes 01. The shape formed by the first helical conical surface 421 and the second helical conical surface 422 of the tapered hole of the bidirectional tapered hole 41 is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body 2, wherein the right-angled side is coincident with the central axis of the columnar body; and the right-angled trapezoid union is formed by symmetrically and oppositely jointing lower bottom sides of two right-angled trapezoids with the same lower bottom sides and upper bottom sides and different right-angled sides. The right-angled trapezoid union refers to a special geometry, which is formed by symmetrically and oppositely jointing the lower bottom sides of two right-angled trapezoids with the same lower bottom sides and upper bottom sides and different right-angled sides and has the upper bottom sides respectively located at both ends of the right-angled trapezoid union.

According to the connection structure of the bolt and double nuts in the present embodiment, the double nuts include a nut body 21 and a nut body 22. The nut body 21 is located on the left side of a fastened workpiece 130, and the nut body 22 is located on the right side of the fastened workpiece 130. When the bolt and the double nuts work, the relationship between the connection structure and the fastened workpiece 130 is rigid connection. The rigid connection is that a nut end face bearing surface and a bearing surface of the workpiece 130 are mutually bearing surfaces, including a locking bearing surface 111 and a locking bearing surface 112. The workpiece 130 refers to a connected object including the workpiece 130.

In the present embodiment, the thread operation bearing surfaces are different and include a tapered thread bearing surface 121 and a tapered thread bearing surface 122. When the cylindrical body 2 is located on the left side of the fastened workpiece 130, that is, when the left end face of the fastened workpiece 130 and the right end face of the cylindrical body 2, i.e., the left nut body 21, is the locking bearing surface 111 of the left nut body 21 and the fastened workpiece 130, a right helical conical surface of the left nut body 21 and the columnar body 3, i.e., a screw body 31. Namely, the second helical conical surface 422 of the tapered hole and the second helical conical surface 722 of the truncated cone body are tapered thread bearing surfaces 122, and the second helical conical surface 422 of the tapered hole and the second helical conical surface 722 of the truncated cone body are mutually bearing surfaces. When the cylindrical body 2 is located on the right side of the fastened workpiece 130, that is, when the right end face of the fastened workpiece 130 and the left end face of the cylindrical body 2, i.e., the right nut body 22, is the locking bearing surface 112 of the right nut body 22 and the fastened workpiece 130, a left helical conical surface of the right nut body 22 and the columnar body 3, i.e., the screw body 31, is a thread operation bearing surface. Namely, the first helical conical surface 421 of the tapered hole and the first helical conical surface 721 of the truncated cone body are tapered thread bearing surfaces 121, and the first helical conical surface 421 of the tapered hole and the first helical conical surface 721 of the truncated cone body are mutually bearing surfaces.

According to the bolt and nut of the bidirectional tapered thread, during transmission connection, by virtue of screwed connection between the bidirectional tapered hole 41 and the bidirectional truncated cone body 71 and bidirectional bearing, when the external thread 9 and the internal thread 6 form the thread pair 10, a clearance 101 must be reserved between the bidirectional truncated cone body 71 and the bidirectional tapered hole 41. If oil and other media exist between the internal thread 6 and the external thread 9 for lubrication, a bearing oil film will be easily formed; and the clearance 101 is beneficial to the formation of the bearing oil film. The tapered thread connection pair 10 is equivalent to a set of sliding bearing pairs composed of one and/or several pairs of sliding bearings, i.e., each pitch of the bidirectional tapered internal thread 6 bidirectionally contains a corresponding pitch of bidirectional tapered external thread 9 to form a pair of sliding bearings. The number of sliding bearings is adjusted according to application conditions. Namely, the number of the effective bidirectional jointed, i.e., the effective bidirectional contact cohered, containing and contained thread pitches of the bidirectional tapered internal thread 6 and the bidirectional tapered external thread 9 is designed according to the application conditions. The multidirectional positioning in multiple directions such as radial, axial, angular and circumferential directions, preferably through the containment of the bidirectional truncated cone body 7 by the bidirectional tapered hole 4 constitutes a special synthesis technology of the special cone pair and the thread pair to ensure the precision, efficiency and reliability of the tapered thread technology, particularly the transmission connection of the connection structure of the bolt of the bidirectional tapered thread and the nut.

When the bolt of the bidirectional tapered thread and the nut is used for fastening connection and sealing connection, the technical performances are realized through the screwing connection of the bidirectional tapered hole 41 and the bidirectional truncated cone body 71, i.e., are realized through the sizing of the first helical conical surface 721 of the truncated cone body and the first helical conical surface 421 of the tapered hole until interference and/or the sizing of the second helical conical surface 722 of the truncated cone body and the second helical conical surface 422 of the tapered hole until interference. The load is borne in one direction and/or respectively borne in two directions at the same time according to the application conditions, i.e., the bidirectional truncated cone body 71 and the bidirectional tapered hole 41 are guided by the helical line to align the inner diameter and the outer diameter of the internal cone and the external cone until the first helical conical surface 421 of the tapered hole is adhered with the first helical conical surface 721 of the truncated cone body until the interference contact is achieved, and/or the second helical conical surface 422 of the tapered hole is cohered with the second helical conical surface 722 of the truncated cone body until the sizing interference contact is achieved, so as to realize the technical performances of a mechanical mechanism, such as connection, locking, anti-loosening, bearing, fatigue and sealing.

Therefore, the technical performances such as the transmission precision and efficiency, the load bearing capacity, the locking force of self-locking, the anti-loosening ability and the sealing performance of the mechanical mechanism using the bolt and nut of the bidirectional tapered thread are related to the sizes of the first helical conical surface 721 of the truncated cone body and the formed left taper 95, i.e., the first taper angle α1, the second helical conical surface 722 of the truncated cone body and the formed right taper 96, i.e., the second taper angle α2, and the sizes of the first helical conical surface 421 of the tapered hole and the formed left taper 95, i.e., the first taper angle α1, and the second helical conical surface 422 of the tapered hole and the formed right taper 96. Material friction coefficient, processing quality and application conditions of the columnar body 3 and the cylindrical body 2 also have a certain impact on the technical performances.

In the bolt and nut of the bidirectional tapered thread, when the right-angled trapezoid union rotates a circle at a constant speed, the axial movement distance of the right-angled trapezoid union is at least double the length of the sum of the right-angled sides of two right-angled trapezoids with the same lower bottom sides and upper bottom sides and different right-angled sides. The structure ensures that the first helical conical surface 721 and the second helical conical surface 722 of the truncated cone body and the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the bolt and nut of the bidirectional tapered thread, when the right-angled trapezoid union rotates a circle at a constant speed, the axial movement distance of the right-angled trapezoid union is equal to the length of the sum of the right-angled sides of two right-angled trapezoids with the same lower bottom sides and upper bottom sides and different right-angled sides. The structure ensures that the first helical conical surface 721 of the truncated cone body and the second helical conical surface 722 of the truncated cone body and the first helical conical surface 421 and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the bolt and nut of the bidirectional tapered thread, the first helical conical surface 721 of the truncated cone body and the second helical conical surface 722 of the truncated cone body are both continuous helical surfaces or discontinuous helical surfaces; and the first helical conical surface 421 of the tapered hole and the second helical conical surface 422 of the tapered hole are both continuous helical surfaces or discontinuous helical surfaces.

In the bolt and nut of the bidirectional tapered thread, when the connecting hole of the cylindrical body 2 is screwed into the screw-in end of the columnar body 3, the screw-in direction is required, i.e., the connecting hole of the cylindrical body 2 cannot be reversely screwed in.

In the bolt and nut of the bidirectional tapered thread, a head with the size greater than an outer diameter of the columnar body 3 is arranged at one end of the columnar body 3, and/or a head with the size smaller than a minor diameter of the bidirectional tapered external thread 9 of a screw body 31 of the columnar body 3 is arranged at one end and/or two ends of the columnar body 3, wherein the connecting hole is a threaded hole formed in a nut 21. Namely, the columnar body 3 connected with the head is a bolt; and the columnar body having no head and/or having heads at both ends smaller than the minor diameter of the bidirectional tapered external thread 9 and/or having no thread at the middle and having the bidirectional tapered external threads 9 at both ends is a stud, wherein the connecting hole is formed in the nut 21.

Compared with the prior art, the tapered thread connection pair 10 of the bolt and nut connection structure of the bidirectional tapered thread has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of the cone pair formed by coaxially aligning the inner diameter and the outer diameter of the internal cone and the external cone to achieve interference fit, can prevent loosening phenomenon during connection, and has self-locking and self-positioning functions

### Embodiment 2

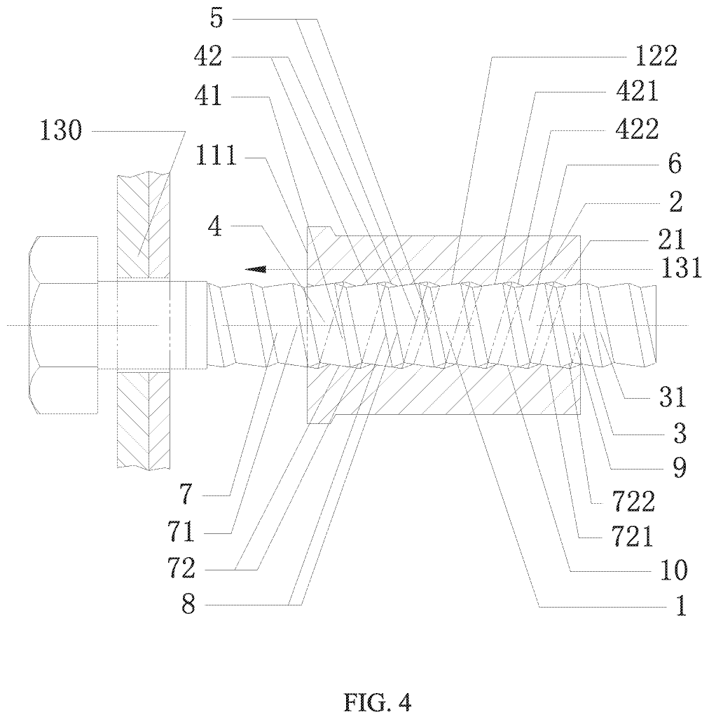

As shown in FIG. 4, the structures, principles and implementation steps in the present embodiment are similar to those in the embodiment 1. The differences are that, in the present embodiment, a connection structure of bolts and single nuts is adopted, and the bolt body is provided with a hexagon head part greater than the screw body 31. When the hexagon head part is located on the left side, the cylindrical body 2, i.e., the nut body 21, i.e., the single nut, is located on the right side of the fastened workpiece 130. During operation, the relationship between the connection structure of the bolts and the single nuts in the present embodiment and the fastened workpiece 130 is also the rigid connection. The rigid connection is that opposite end faces of an end face of the nut body 21 and an end face of the workpiece 130 are mutually bearing surfaces. The bearing surfaces are the locking bearing surfaces 111. The workpiece 130 refers to a connected object including the workpiece 130.

In the present embodiment, the thread operation bearing surface is the tapered thread bearing surface 122, i.e., the cylindrical body 2, i.e., the nut body 21, i.e., the single nut, is located on the right side of the fastened workpiece 130. During operation of the connection structure of the bolts and the single nuts, the right end face of the fastened workpiece and the left end face of the nut body 21 are the locking bearing surfaces 111 of the nut body 21 and the fastened workpiece 130, a left helical conical surface of the nut body 21 and the columnar body 3, i.e., the screw body 31, i.e., the bolted bidirectional tapered thread 1, is a thread operation bearing surface. Namely, the first helical conical surface 421 of the tapered hole and the first helical conical surface 721 of the truncated cone body of the tapered external thread 9 are tapered thread bearing surfaces 122, and the first helical conical surface 421 of the tapered hole and the first helical conical surface 721 of the truncated cone body are mutually bearing surfaces.

In the present embodiment, when the bolt hexagon head part is located on the right side, the structures, principles and implementation steps are similar to those in the present embodiment.

### Embodiment 3

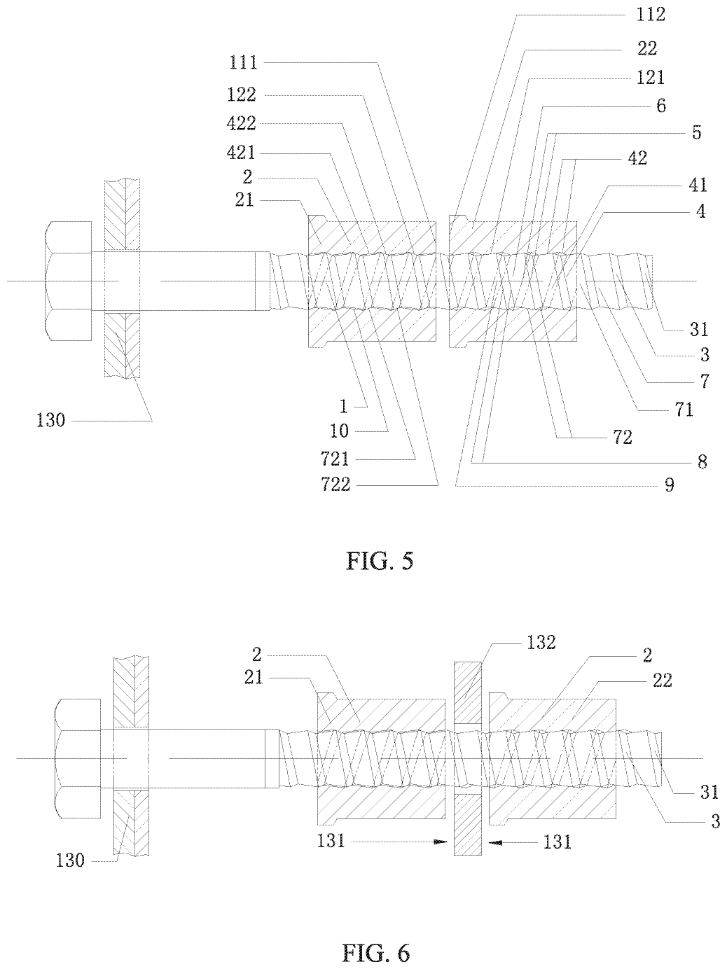

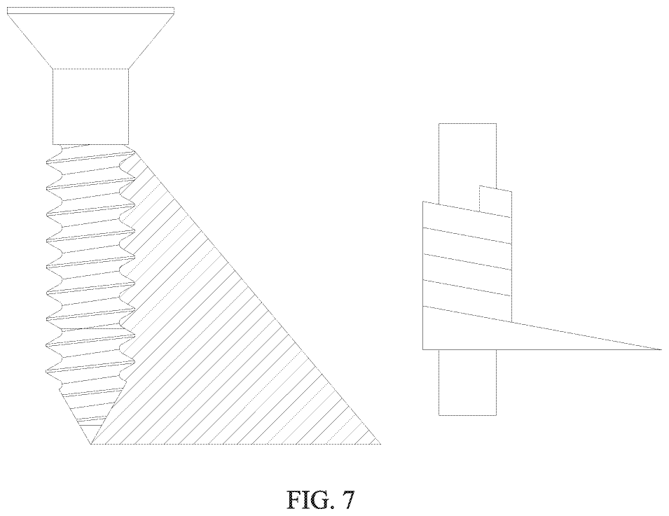

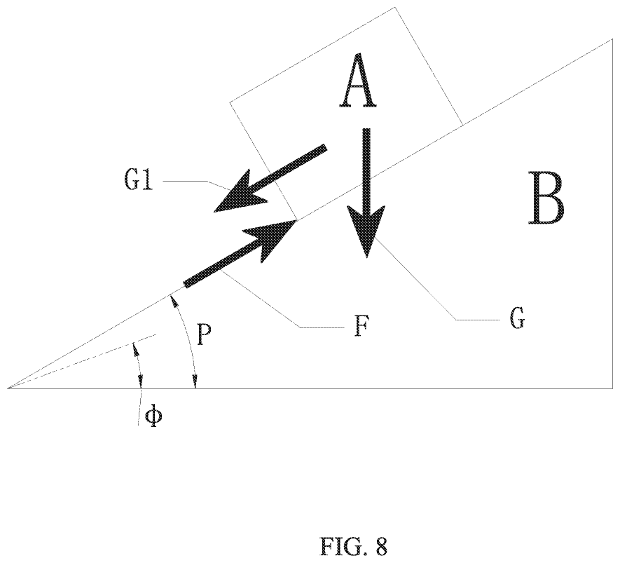

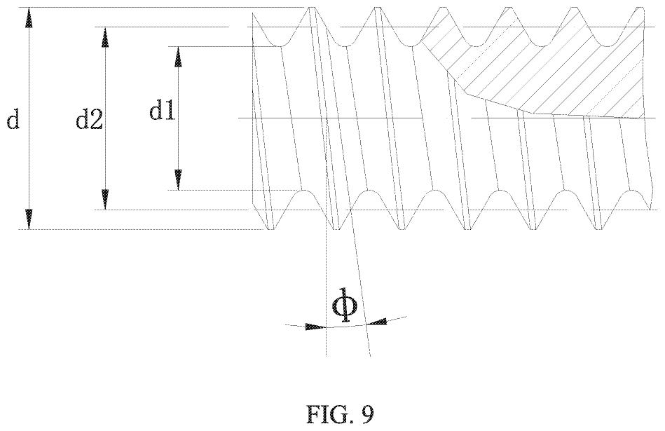

As shown in FIG. 5, the structures, principles and implementation steps in the present embodiment are similar to those in the embodiment 1. The differences are that, position relations of the double nuts and the fastened workpiece 130 are different. The double nuts include a nut body 21 and a nut body 22, and the bolt body is provided with a hexagon head part greater than the screw body 31. When the hexagon head part is located on the left side, both the nut body 21 and the nut body 22 are located on the right side of the fastened workpiece 130. During operation of the connection structure of the bolts and the double nuts, the relationship between the nut body 21 and the nut body 22 and the fastened workpiece 130 is the non-rigid connection. The non-rigid connection is that, opposite lateral end faces of the two nuts, i.e., the nut body 21 and the nut body 22 are mutually bearing surfaces. The bearing surfaces include the locking bearing surface 111 and the locking bearing surface 112, and are mainly applied to non-rigid connection workpieces 130 such as non-rigid materials or driving parts or application fields in which requirements are met by virtue of double-nut installation. The workpiece 130 refers to a connected object including the workpiece 130.

In the present embodiment, the thread operation bearing surfaces are different and include a tapered thread bearing surface 121 and a tapered thread bearing surface 122. The cylindrical body 2 includes the left nut body 21 and the right nut body 22. The right end face of the left nut body 21, i.e., the locking bearing surface 111 and the left end face of the right nut body 22, i.e., the locking bearing surface 122 are in opposite and direct contact and are mutually locking bearing surfaces. When the right end face of the left nut body 21 is the locking bearing surface 111, a right helical conical surface of the left nut body 21 and the columnar body 3, i.e., a screw body 31, i.e., the bolted bidirectional tapered thread 1, is a thread operation bearing surface. Namely, the second helical conical surface 422 of the tapered hole and the second helical conical surface 722 of the truncated cone body of the tapered external thread 9 are tapered thread bearing surfaces 122, and the special conical surface 42 of the traditional internal thread 6 and the second helical conical surface 722 of the truncated cone body are mutually bearing surfaces. When the left end face of the right nut body 22 is the locking bearing surface 122, a left helical conical surface of the right nut body 22 and the columnar body 3, i.e., the screw body 31, i.e., the bolted bidirectional tapered thread 1, is a thread operation bearing surface. Namely, the first helical conical surface 421 of the tapered hole and the first helical conical surface 721 of the truncated cone body of the tapered external thread 9 are tapered thread bearing surfaces 121, and the first helical conical surface 421 of the tapered hole and the first helical conical surface 721 of the truncated cone body are mutually bearing surfaces.

In the present embodiment, when the cylindrical body 2 located on the inner side, i.e., the nut body 21 adjacent to the fastened workpiece 130, has been effectively jointed with the columnar body 3, i.e., the screw body 31, i.e., the bolt, that is, when the internal thread 6 and the external thread 9 forming the tapered thread connection pair 10 are effectively cohered together, the cylindrical body 2 located on the outer side, i.e., a nut body that is not adjacent to the fastened workpiece 130, may maintain the original shape and/or be removed according to needs of application conditions, while only one nut is remained (e.g., application fields in which requirements on equipment lightweight exist or connection technology reliability is ensured without double nuts). The removed nut body 22 does not serve as a connecting nut, but an installation process nut. Internal threads of the installation process nuts are manufactured from the bidirectional tapered threads, and may also be nut bodies 22 manufactured from threads of other threads that may be screwed with the tapered threads 1, including triangular threads, trapezoidal threads, sawtooth threads and the like, which is the precondition of ensuring the connection technology reliability. The tapered thread connection pair 10 is a closed loop fastening technology system. Namely, after the internal thread 6 and the external thread 9 of the tapered thread connection pair 10 are effectively cohered together, the tapered thread connection pair 10 may form an independent technology system itself without depending on technical compensation of a third party, so as to ensure the technical effectiveness of the connection technology system. Even if there is no support of other objects, and even if a gap exists between the thread connection pair 10 and the fastened workpiece 130, effectiveness of the tapered thread connection pair 10 is not influenced, which contributes to greatly lightening equipment weight, removing invalid loads, and improving technical requirements of equipment, such as payload capability, brake performance and energy conservation and emission reduction. The above descriptions are thread technology advantages that are not owned by other thread technologies when the relationship between the tapered thread connection pair 10 of the bolt and nut connection structure of the bidirectional tapered thread and the fastened workpiece 130 is the rigid connection or non-rigid connection.

In the present embodiment, when the bolt hexagon head part is located on the right side, both the nut body 21 and the nut body 22 are located on the right side of the fastened workpiece 130, and the structures, principles and implementation steps are similar to those in the present embodiment.

### Embodiment 4

As shown in FIG. 6, the structures, principles and implementation steps in the present embodiment are similar to those in the embodiment 1 and embodiment 3. The differences are that, in the present embodiment, a spacer like a gasket 132 is increased between the nut body 21 and the nut body 22 on the basis of the embodiment 3. Namely, the right end face of the left nut body 21 and the left end face of the right nut body 22 are in opposite and indirect contact by virtue of the gasket 132 so as to be indirectly mutually locking bearing surfaces, i.e., a mutual relation between the right end face of the left nut body 21 and the left end face of the right nut body 22 is changed from directly mutual locking bearing surfaces to indirectly mutual locking bearing surfaces.

The specific embodiments described herein are merely examples to illustrate the spirit of the present invention. Those skilled in the art of the present invention can make various modifications or supplements to the specific embodiments described or substitute with similar modes without deviating from the spirit of the present invention or going beyond the scope defined by the appended claims.

The terms such as tapered thread 1, cylindrical body 2, nut body 21, nut body 22, columnar body 3, screw body 31, tapered hole 4, bidirectional tapered hole 41, conical surface 42 of bidirectional tapered hole, first helical conical surface 421 of tapered hole, first taper angle α1, second helical conical surface 422 of tapered hole, second taper angle α2, internal helical line 5, internal thread 6, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, olive-like shape 93, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirror image, shaft sleeve, shaft, single tapered body, double tapered body, cone body, internal cone body, tapered hole, external cone body, taper body, cone pair, helical structure, helical movement, thread body, complete unit thread, axial force, axial force angle, counter-axial force, counter-axial force angle, centripetal force, counter-centripetal force, reversely collinear, internal stress, bidirectional force, unidirectional force, sliding bearing, sliding bearing pair, locking bearing surface 111, locking bearing surface 112, tapered thread bearing surface 122, tapered thread bearing surface 121, non-entity space, material entity, workpiece 130, nut body locking direction 131, non-rigid connection, non-rigid material, driving part, gasket 132 and the like are widely used, but the possibility of using other terms is not excluded. These terms are merely used to describe and explain the essence of the present invention more conveniently; and it is contrary to the spirit of the present invention to interpret the terms as any additional limitation.

We claim:

1. A bolt and nut connection structure of an olive-shape bidirectional tapered thread with smaller left taper and greater right taper, i.e., a bolt and nut connection structure of an olive-like (left taper is smaller than right taper) asymmetric bidirectional tapered thread, comprising: an external thread (9) and an internal thread (6) in thread fit, wherein a complete unit thread of the olive-like (left taper is smaller than right taper) asymmetric bidirectional tapered thread (1) is a helical asymmetric bidirectional tapered body in an olive-like shape (93) and with a left taper (95) smaller than a right taper (96) and with a large middle and two small ends, comprising a bidirectional tapered hole (41) and/or a bidirectional truncated cone body (71); a thread body of the internal thread (6) is a helical bidirectional tapered hole (41) on an inner surface of a cylindrical body (2) and exists in the form of “non-entity space”; a thread body of the external thread (9) is a helical bidirectional truncated cone body (71) on an outer surface of a columnar body (3) and exists in the form of “material entity”; the left taper (95) formed on a left tapered surface of the asymmetric bidirectional tapered body corresponds to a first taper angle (α1); the right taper (96) formed on a right tapered surface corresponds to a second taper angle (α2); the left taper (95) and the right taper (96) have opposite directions and different tapers; the internal thread (6) and the external thread (9) contain the cone body through tapered holes until inner and outer tapered surfaces bear each other, technical performances mainly depend on the size of conical surfaces and tapers of thread bodies fitted with each other; preferably, the first taper angle (α1) is greater than 0 and smaller than 53°; and the second taper angle (α2) is greater than 0 and smaller than 53°; and in individual special fields, preferably, the second taper angle (α2) is greater than or equal to 53° and smaller than 180°.

2. The connection structure according to claim 1, wherein the bidirectional tapered internal thread (6) in the olive-like shape (93) comprises a left conical surface of a conical surface (42) of the bidirectional tapered hole, i.e., a first helical conical surface (421) of the tapered hole, a right conical surface, i.e., a second helical conical surface (422) of the tapered hole, and an internal helical line (5); the shape formed by the first helical conical surface (421) of the tapered hole and the second helical conical surface (422) of the tapered hole, i.e., the bidirectional helical conical surfaces, is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the cylindrical body (2), wherein the right-angled side is coincident with the central axis of the cylindrical body (3); the right-angled trapezoid union is formed by symmetrically and oppositely jointing lower bottom sides of two right-angled trapezoids with the same lower bottom sides and upper bottom sides and different right-angled sides; the bidirectional tapered external thread (9) in the olive-like shape (93) comprises a left conical surface of a conical surface (72) of the bidirectional truncated cone body, i.e., a first helical conical surface (721) of the truncated cone body, a right conical surface, i.e., a second helical conical surface (722) of the truncated cone body, and an external helical line (8); the shape formed by the first helical conical surface (721) of the truncated cone body and the second helical conical surface (722) of the truncated cone body, i.e., the bidirectional helical conical surfaces, is the same as the shape of a helical outer flank of a rotating body, which circumferentially rotates at a constant speed by using a right-angled side of a right-angled trapezoid union as a rotating center and is formed by two hypotenuses of the right-angled trapezoid union when the right-angled trapezoid union axially moves at a constant speed along a central axis of the columnar body (3), wherein the right-angled side is coincident with the central axis of the columnar body (3); and the right-angled trapezoid union is formed by symmetrically and oppositely jointing lower bottom sides of two right-angled trapezoids with the same lower bottom sides and upper bottom sides and different right-angled sides.

3. The connection structure according to claim 2, wherein when the right-angled trapezoid union rotates a circle at a constant speed, the axial movement distance of the right-angled trapezoid union is at least double the length of the sum of the right-angled sides of two right-angled trapezoids of the right-angled trapezoid union.

4. The connection structure according to claim 2, wherein when the right-angled trapezoid union rotates a circle at a constant speed, the axial movement distance of the right-angled trapezoid union is equal to the length of the sum of the right-angled sides of two right-angled trapezoids of the right-angled trapezoid union.

5. The connection structure according to claim 1, wherein the left conical surface and the right conical surface of the bidirectional tapered body, i.e., the first helical conical surface (421) of the tapered hole and the second helical conical surface (422) of the tapered hole and the internal helical line (5) are continuous helical surfaces or discontinuous helical surfaces; and/or the first helical conical surface (721) of the truncated cone body and the second helical conical surface (722) of the truncated cone body and the external helical line (8) are continuous helical surfaces or discontinuous helical surfaces.

6. The connection structure according to claim 1, wherein the internal thread (6) is formed by symmetrically and oppositely jointing the lower bottom surfaces of two tapered holes (4) with the same lower bottom surfaces and upper top surfaces and different cone heights, and the upper top surfaces are located at both ends of the bidirectional tapered hole (41) to form the asymmetric bidirectional tapered thread (1) in the olive-like shape (93), comprising that the upper top surfaces are respectively jointed with the upper top surfaces of the adjacent bidirectional tapered holes (41) and/or will be respectively jointed with the upper top surfaces of the adjacent bidirectional tapered holes (41) to form a helical shape to form the asymmetric bidirectional tapered internal thread (6) in the olive-like shape (93); the external thread (9) is formed by symmetrically and oppositely jointing the lower bottom surfaces of two truncated cone bodies (7) with the same lower bottom surfaces and upper top surfaces and different cone heights, and the upper top surfaces are located at both ends of the bidirectional truncated cone body (71) to form the asymmetric bidirectional tapered thread (1) in the olive-like shape (93), comprising that the upper top surfaces are respectively jointed with the upper top surfaces of the adjacent bidirectional truncated cone bodies (71) and/or will be respectively jointed with the upper top surfaces of the adjacent bidirectional truncated cone bodies (71) to form a helical shape to form the asymmetric bidirectional tapered external thread (9) in the olive-like shape (93).

7. The connection structure according to claim 1, wherein self-locking of the thread pair (10) composed of the internal thread (6) and the external thread (9) is produced as follows: the first helical conical surface (421) of the tapered hole and the second helical conical surface (422) of the tapered hole matched with the first helical conical surface (721) of the truncated cone body and the second helical conical surface (722) of the truncated cone body take the contact surface as the supporting surface to make the inner and outer cones are centered in inner and outer diameters under the guidance of the helical lines until the conical surface (72) of the bidirectional truncated cone body is cohered with the special conical surface (42) to achieve one-directional bearing of the helical conical surface and/or bidirectional simultaneous bearing of the helical conical surface and/or until the sizing fit and self-positioning contact and/or until the sizing interference contact.

8. The connection structure according to claim 1, wherein the bolt and double-nut connection structure is adopted, the double nuts are respectively located on the left and right sides of a fastened workpiece and/or the bolt and single-nut connection structure is adopted, comprising a single nut (21) located on the right side or left side of the fastened workpiece and/or the bolt and double-nut connection structure is adopted, and the double nuts are located on a single side of the fastened workpiece; moreover, when one nut has been effectively combined with the bolt together, i.e., the internal thread (6) and the external thread (9) forming the tapered thread connection pair (10) are effectively cohered together, another nut may be removed and/or remained; the removed nut serves as an installation process nut; and the internal threads comprise bidirectional tapered threads (1), unidirectional tapered threads and traditional threads that may be in accordance with the technical spirit of the present invention due to mutual thread fit with the bidirectional tapered external thread (9), such as triangular threads, trapezoidal threads, sawtooth threads, rectangular threads and arc threads.

9. The connection structure according to claim 1, wherein when a connecting hole of the cylindrical body (2) is screwed into the screw-in end of the columnar body (3), the screw-in direction is required, i.e., the connecting hole of the cylindrical body (2) cannot be reversely screwed in; the connecting hole is a threaded hole formed in a nut (21) and a nut (22); the connecting hole is formed in the nut (21) and the nut (22); and the nuts refer to objects having a thread structure including nuts on the inner surface of the cylindrical body (2).

10. The connection structure according to claim 1, wherein the internal thread (6) and/or the external thread (9) comprise single-pitch thread bodies that are incomplete tapered geometries, i.e., the single-pitch thread bodies are incomplete unit threads.
